(19) United States
(12) Patent Application Publication
(10) Pub. No.: US 2007/0258106 A1
(43) Pub. Date: Nov. 8, 2007

(54) Communication Terminal Device with Timestamp Function

(75) Inventors: Katsunori ISHIYAMA, Kyoto-shi (JP); Masahiro IIDA, Kyoto-shi (JP)

Correspondence Address: HOGAN & HARTSON L.L.P., 1999 AVENUE OF THE STARS, SUITE 1400, LOS ANGELES, CA, 90067, US

(73) Assignee: MURATA KIKAI KABUSHIKI KAISHA, Kyoto-shi (JP)

(21) Appl. No.: 11/691,380

(22) Filed: Mar. 26, 2007

(30) Foreign Application Priority Data
Mar. 31, 2006 (JP) 2006-096274

(51) Int. Cl. G06F 3/12

(52) U.S. Cl. 358/1.15

(57) ABSTRACT

A communication terminal device using timestamp technology officially certifies transmission completion time. When a start key is pressed, and e-document scan is instructed, scanned image data is stored as an e-document along with a timestamp received from a Time Stamping Authority (TSA). When facsimile transmission is carried out, and log e-document storing transmission is selected, a hash value of data composed of communication log data and image data transmitted by facsimile is transmitted to the TSA, and log file data and a timestamp are stored as an e-document.

### RELATED APPLICATIONS

This application claims priority under 35 USC 119 in Japanese patent application no. 2006-096274, filed on Mar. 31, 2006, the entire contents of which are incorporated herein by reference.

### BACKGROUND OF THE INVENTION

1. Field of the Invention

The present invention relates to a communication terminal device, such as a digital Multi Function Peripheral (MFP), including a function for acquiring a timestamp from a Time Stamping Authority (TSA).

2. Description of the Related Art

In a communication terminal device such as a digital MFP, the transmission time is sometimes important. For example, in a case in which a contract has been made to respond within a certain period of time after receiving a facsimile, the transmission time is important. Typically, the transmission time is certified by a journal function based on a transmission report and/or a communication management record.

The transmission report is used for confirming that facsimile communication with a receiving side has been properly carried out. When facsimile transmission is properly carried out, and the transmission report is set to be output, a facsimile device on a transmitting side records the transmission report onto a recording paper. As illustrated in FIG. 15, a result report section including each of the following items is typically recorded on a transmission report: a title of the transmission report “**Transmission Report**”, transmission date and time, a dial number of a transmission destination, a transmission mode, transmission start date and time, transmission duration, a number of transmitted sheets, a communication result, and a remark column.

A typical digital MFP includes a copier function, a facsimile function, a printer function, and a scanner function or the like. In some such MFPs, a timestamp is assigned to a document image scanned by a scanner, and the document image assigned with the timestamp is stored as an e-document. The timestamp is a technology for certifying the time when an electronic document has been fixed, and is used because digital data is easily altered relative to a paper document. The timestamp certifies when a document was created, and certifies that the document has not been altered by third parties or the creator of the document from the time that the document was created.

In such timestamp technology, first, a hash value of an electronic document is transmitted to the TSA. The TSA encrypts the hash value along with information on accurate time clocked by an atomic clock, and returns the encrypted hash value and information as a timestamp. The returned timestamp is stored along with the electronic document.

When verifying an e-document, the timestamp is decrypted, timestamp time information is confirmed, and a separately calculated hash value of the electronic document is compared with the hash value included in the timestamp to determine whether or not the e-document has been altered. The hash value is a fixed-length value generated using an irreversible one-way function (hash function) from a given original text. The hash value is also known as a message digest. Since it is extremely difficult to obtain the original text from the hash value or create different texts having the same hash value, it is possible to confirm whether or not the original text is identical by comparing the hash values.

As described above, in a communication terminal device such as a digital MFP, the transmission time is conventionally confirmed by the communication management record and the transmission report. However, such confirmation is made based on an assumption that a clock of the device is operating normally. When clock data of the device is not accurate, the communication log data of the device is not valid. In addition, the transmission time can be easily altered by altering the time setting of the device, and such transmission time lacks credibility. Therefore, for example, the communication management record and the transmission report cannot be used when an official certification is required.

### SUMMARY OF THE INVENTION

In order to overcome the above-described problems, the present invention provides a communication terminal device with a timestamp function that officially certifies communication completion time by using timestamp technology.

According to an aspect of the present invention, a communication terminal device with a timestamp function includes a communication unit, which transmits a document, a time certified document storage unit, which stores a time certified document, and a control unit, which assigns a timestamp to the document and stores the document assigned with the timestamp in the time certified document storage unit. In the communication terminal device with the timestamp function, when transmitting the document, the control unit assigns the timestamp to a data file in which a communication log is added to the transmitted document, and stores the data file assigned with the timestamp in the time certified document storage unit.

According to another aspect of the present invention, a communication terminal device with a timestamp function includes a communication unit, which transmits a document, a time certified document storage unit, which stores a time certified document, and a control unit, which assigns a timestamp to the document and stores the document assigned with the timestamp in the time certified document storage unit. In the communication terminal device with the timestamp function, when transmitting the document, the control unit assigns the timestamp to transmission report data of the document, and stores the transmission report data assigned with the timestamp in the time certified document storage unit.

According to another aspect of the present invention, a communication terminal device with a timestamp function includes a communication unit, which transmits a document, and a control unit, which acquires a timestamp from the TSA. In the communication terminal device with the timestamp function, when transmitting the document, the control unit acquires time information from the TSA, and adds the acquired time information to transmission report data of the document.

Furthermore, according to another aspect of the present invention, a communication terminal device with a timestamp function includes a communication unit, which transmits a document, and a control unit, which acquires a timestamp from the TSA. In the communication terminal device with the timestamp function, when transmitting the document, the control unit acquires the timestamp from the TSA, and assigns the acquired timestamp to transmission report data of the document.

According to the above-described communication terminal device with the timestamp function, when transmitting a document, a data file in which a communication log is added to the transmitted document, or transmission report data of the document is assigned with a timestamp and stored. Therefore, transmission time of the document can be certified, and a fact that the transmitted document, the communication log, or a transmission report has not been altered can also be certified.

According to the above-described communication terminal device with the timestamp function, when transmitting a document, time information or a timestamp acquired from the TSA is assigned to transmission report data. Therefore, credibility of time recorded on a transmission report can be increased.

Other features, elements, processes, steps, characteristics and advantages of the present invention will become more apparent from the following detailed description of embodiments of the present invention with reference to the attached drawings.

### BRIEF DESCRIPTION OF THE DRAWINGS

FIG. 1 is a diagram of a network configuration of a system including a digital MFP according to an embodiment of the present invention.

FIG. 2 is a block diagram of a hardware structure of a digital MFP according to an embodiment of the present invention.

FIG. 3 illustrates a detailed structure of a display and operation unit according to an embodiment of the present invention.

FIG. 4 illustrates a file structure of an e-document storage unit according to an embodiment of the present invention.

FIG. 5 illustrates an example of data stored in a management file according to an embodiment of the present invention.

FIG. 6 illustrates an example of a facsimile transmitting function selection screen according to an embodiment of the present invention.

FIG. 7 illustrates an example of a scanning function selection screen according to an embodiment of the present invention.

FIG. 8 illustrates an example of a document selection screen of e-document scan according to an embodiment of the present invention.

FIG. 9 is a flowchart illustrating an operation carried out when a start key is pressed according to an embodiment of the present invention.

FIG. 10 illustrates an example of log file data composed of communication log data and image data transmitted by facsimile according to an embodiment of the present invention.

FIG. 11 illustrates an example of a facsimile transmitting function selection screen according to another embodiment of the invention.

FIG. 12 is a flowchart illustrating an operation carried out when a start key is pressed according to another embodiment of the invention.

FIG. 13 illustrates an example of transmission report data composed of a communication log and transmitted image data according to an embodiment of the present invention.

FIG. 14 illustrates an example of transmission report data assigned with time acquired from the TSA according to an embodiment of the present invention.

FIG. 15 illustrates an example of a conventional transmission report.

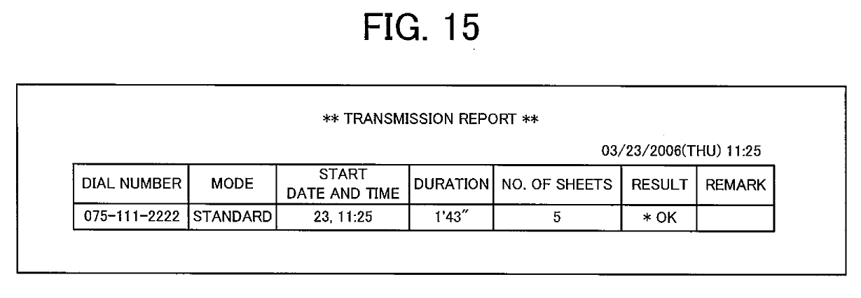

### DETAILED DESCRIPTION OF EMBODIMENTS OF THE INVENTION

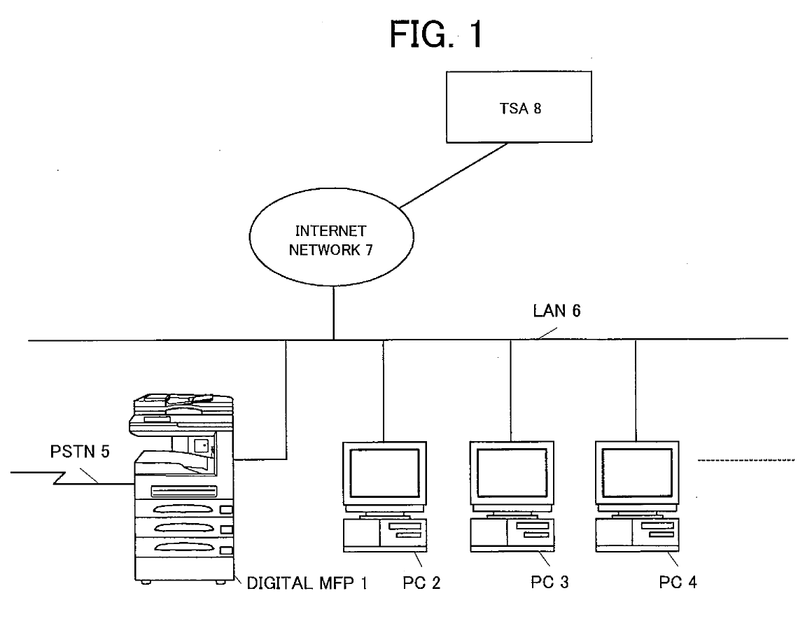

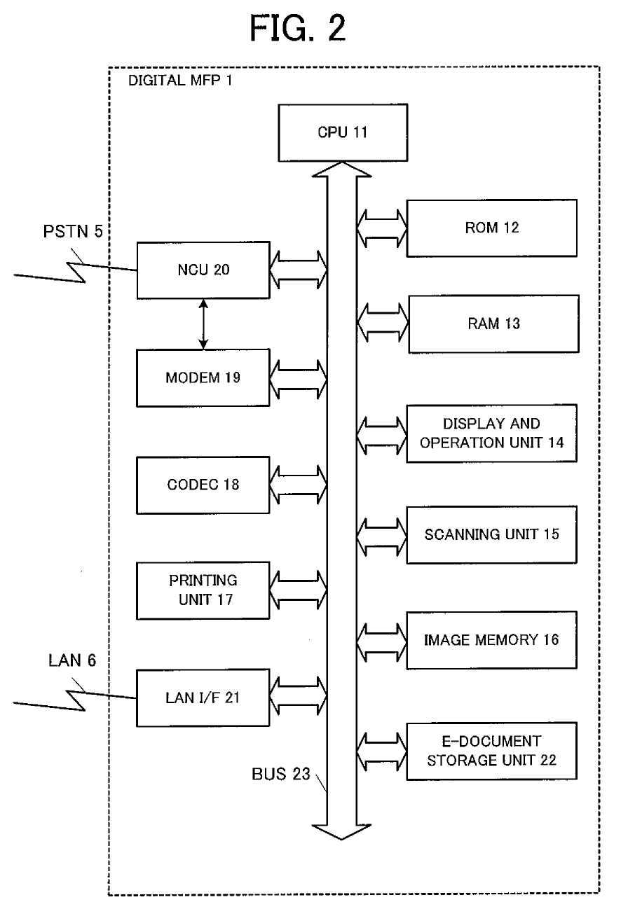

(First Embodiment) A digital MFP as an example of a communication terminal device with a timestamp function according to an embodiment of the present invention is now described. FIG. 1 is a diagram of a network configuration of a system including a digital MFP. FIG. 2 is a block diagram illustrating a hardware structure of the digital MFP.

In FIG. 1, reference numeral 1 denotes a digital MFP, reference numerals 2, 3 and 4 denote a Personal Computer (PC), reference numeral 5 denotes a Public Switched Telephone Network (PSTN) 6 denotes a Local Area Network (LAN), 7 denotes an Internet network, and 8 denotes a Time Stamping Authority (TSA). The digital MFP 1 includes copy mode, printer mode, facsimile mode and mail transmitting functions. The digital MFP 1 is connected to the PSTN 5 and the LAN 6. A plurality of PCs 2, 3, 4 as terminal devices are connected to the LAN 6. The LAN 6 is also connected to the Internet network 7. The digital MFP 1 can transmit and receive mail via the Internet network 7.

The TSA 8 is a time stamping authority. When the TSA 8 receives a hash value of scanned data from the digital MFP 1 via the Internet network 7, the TSA 8 encrypts the received hash value along with information on accurate time clocked by an atomic clock, and returns the encrypted hash value and information as a timestamp.

As illustrated in FIG. 2, the digital MFP 1 includes a Central Processing Unit (CPU) 11, a Read Only Memory (ROM) 12, a Random Access Memory (RAM) 13, a display and operation unit 14, a scanning unit 15, an image memory 16, a printing unit 17, a Coder-Decoder (CODEC) 18, a Modulator-Demodulator (MODEM) 19, a Network Control Unit (NCU) 20, a LAN interface (I/F) 21, and an e-document storage unit 22. Units 11-22 are connected via a bus 23.

The CPU 11 controls the hardware components of the digital MFP 1 via the bus 23. The CPU 11 executes various programs in accordance with a program stored in the ROM 12. The ROM 12 stores various programs and operation messages or the like necessary for operation of the digital MFP 1. The RAM 13 is a Static RAM (SRAM) or the like. The RAM 13 stores temporary data generated when a program is executed, and stores communication log data.

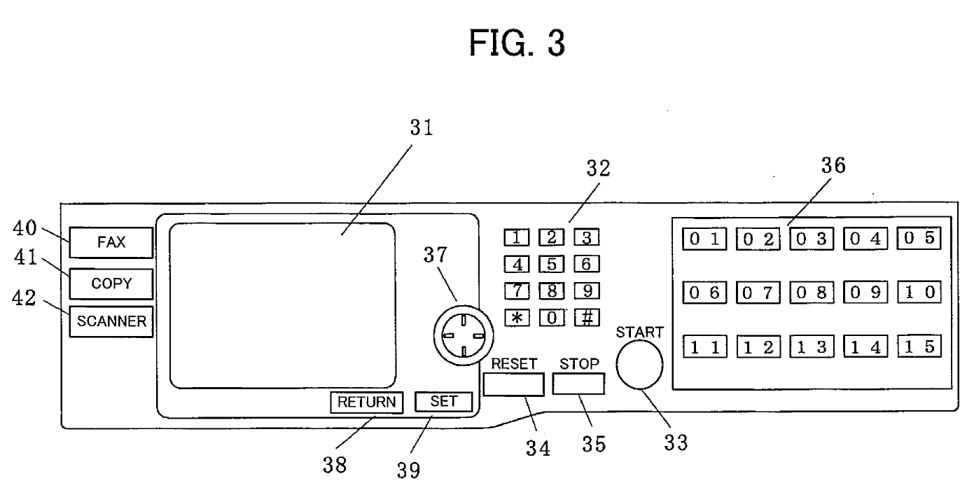

The display and operation unit 14 includes a display unit, which displays an operation status of the digital MFP 1 and displays an operation screen for various functions, and a plurality of keys for operating the digital MFP 1. As illustrated in FIG. 3, the display and operation unit 14 includes a Liquid Crystal Display (LCD) display unit 31 as the display unit and a plurality of operation keys. Touch-screen switches are provided to the LCD display unit 31. By pressing an item displayed on the LCD display unit 31, a corresponding item is selected or a function is executed. The operation keys include a ten-key numeric pad 32, a start key 33, a reset key 34, a stop key 35, a plurality of one-touch dial keys 36, a cross key 37, a return key 38, a set key 39, a FAX switching key 40, a copy switching key 41, and a scanner switching key 42. The LCD display unit 31 may substitute a portion or all of these operation keys.

The scanning unit 15 includes an original placing table for an Auto Document Feeder (ADF) and/or a Flat Bed Scanner (FBS) or the like. The scanning unit 15 scans an original by a scanner using a Charge-Coupled Device (CCD) or the like, and outputs dot image data. The image memory 16 includes a Dynamic RAM (DRAM) or the like. The image memory 16 stores image data to be transmitted, received image data, or image data scanned by the scanning unit 15. The printing unit 17 includes an electrophotographic printer device. The printing unit 17 prints out received data, copied original data, or print data transmitted from the remote PCs 2, 3, 4.

The CODEC 18 encodes and decodes according to a prescribed protocol. For transmitting image data scanned from an original, the CODEC 18 encodes the image data by the Modified Huffman (MH), the Modified Read (MR) or the Modified MR (MMR) scheme. The CODEC 18 decodes image data received from a remote terminal. The CODEC 18 also encodes and decodes according to the Tagged Image File Format (TIFF) scheme, which is an image format generally used as a file attachable to electronic mail.

The MODEM 19 is connected to the bus 23, and includes functions' as a faxmodem capable of carrying out facsimile communication. The MODEM 19 is also connected to the NCU 20, which is also connected to the bus 23. The NCU 20 is hardware for connecting and disconnecting an analog communication line. The NCU 20 connects the MODEM 19 to the PSTN 5 according to necessity. The LAN I/F 21 is connected to the LAN 6. The LAN I/F 21 receives a signal from the Internet network 7, and transmits a signal and/or data to the LAN 6. The LAN I/F 21 executes interface processing such as signal conversion and protocol conversion.

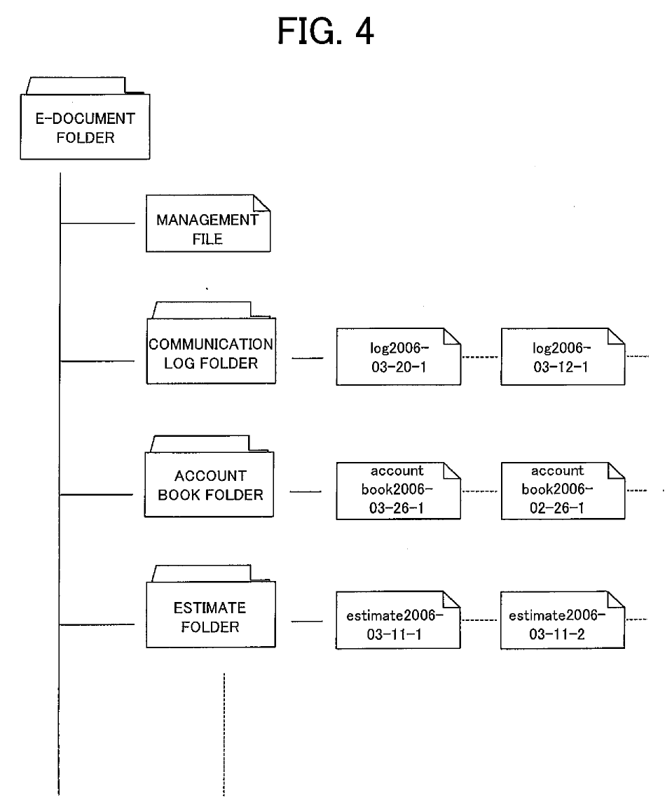

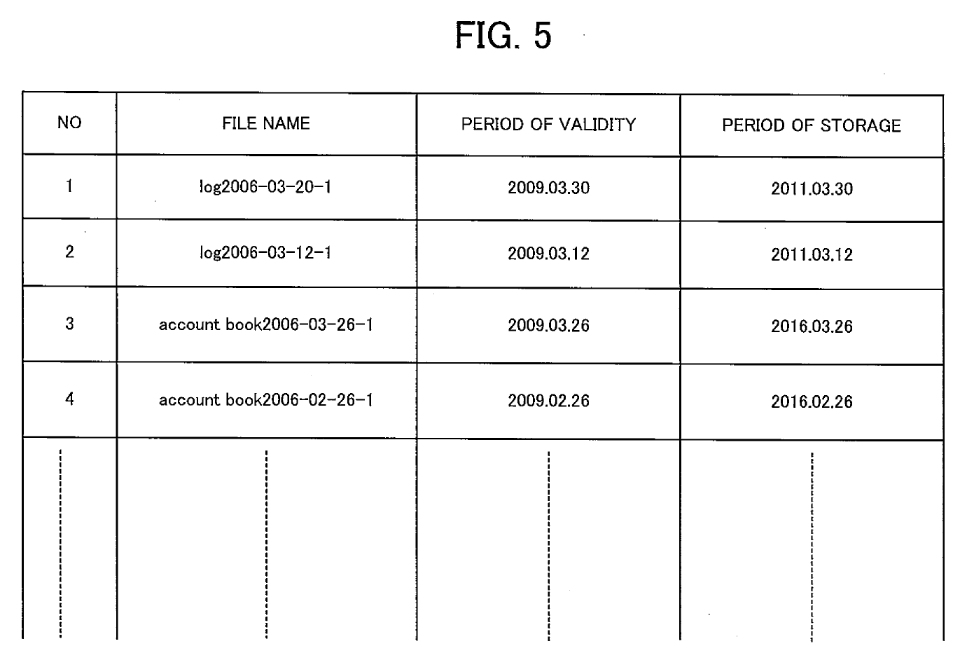

The e-document storage unit 22 is a storage unit that stores e-documents per document type. As illustrated in FIG. 4, the e-document storage unit 22 includes a management file of e-documents, a communication log folder, and folders for documents such as account book, estimate, memorandum, purchase order, etc. Each document folder stores a file which includes a scanned document and a timestamp. The file is assigned with a file name including a character string, a date, and a consecutive number that are capable of identifying a document name. The communication log folder stores a file that includes data composed of transmitted image data and communication log data, and includes a timestamp, under a file name including a character string such as “log”, a date, and a consecutive number. As illustrated in FIG. 5, the management file stores a file name of each e-document, a period of validity of a timestamp, and a period of storage of corresponding data.

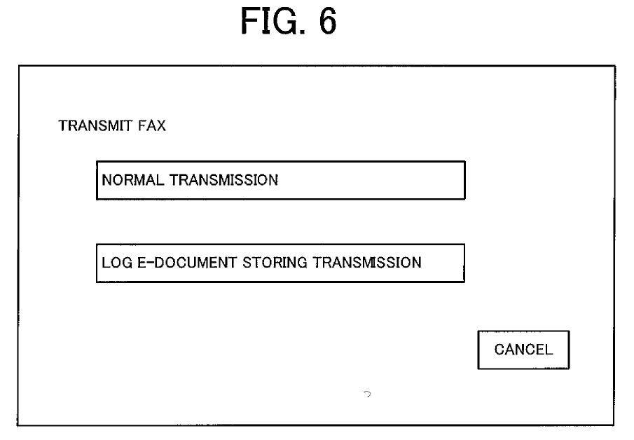

In the digital MFP 1, when carrying out facsimile transmission, a user sets an original to be transmitted on the scanning unit 15, and presses the FAX switching key 40 on the display and operation unit 14. A facsimile transmitting function selection screen such as that illustrated in FIG. 6 is then displayed on the LCD display unit 31. At the facsimile transmitting function selection screen, either “normal transmission” or “log e-document storing transmission” can be selected. When “log e-document storing transmission” is selected, data composed of the transmitted image data and the communication log data, and the timestamp is stored in the e-document storage unit 22. When either the “normal transmission” or the “log e-document storing transmission” is selected, a transmission destination input field (not illustrated) is displayed on the LCD display unit 31. After a dial number of a transmission destination is input by operating the ten-key numeric pad 32, or after a transmission destination is selected by operating one-touch dial keys 36, the start key 33 is pressed, and facsimile transmission of image data of the original is carried out.

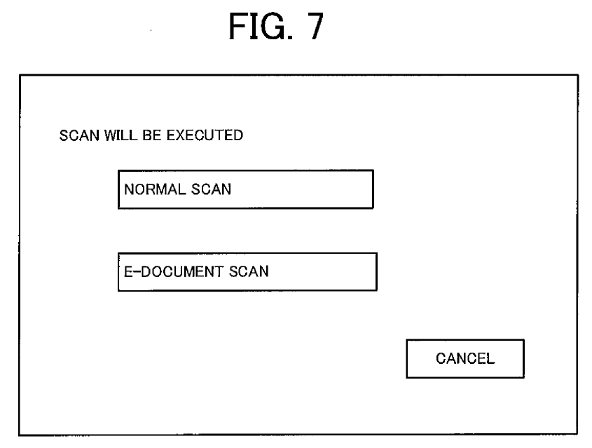

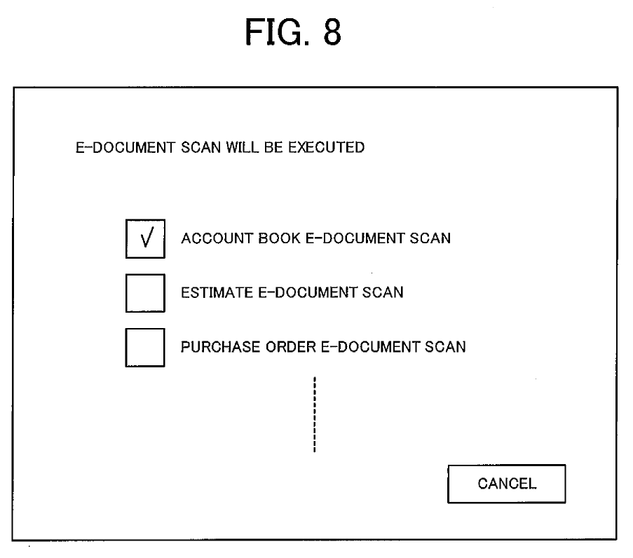

When converting a document into an e-document, the scanner switching key 42 on the display and operation unit 14 is pressed, and a scanning function selection screen such as that illustrated in FIG. 7 is then displayed on the LCD display unit 31. On the scanning function selection screen, selection buttons for normal scan and e-document scan are displayed. When “normal scan” is selected, a normal scan is executed, and when “e-document scan” is selected, a document selection screen of an e-document scan such as that illustrated in FIG. 8 is displayed on the LCD display unit 31. The document selection screen displays a screen for selecting a document type to be executed with e-document scan, e.g. an account book e-document scan, an estimate e-document scan, and a purchase order e-document scan. When one of the document types is selected, the start key 33 is pressed, and the document is then converted into the e-document.

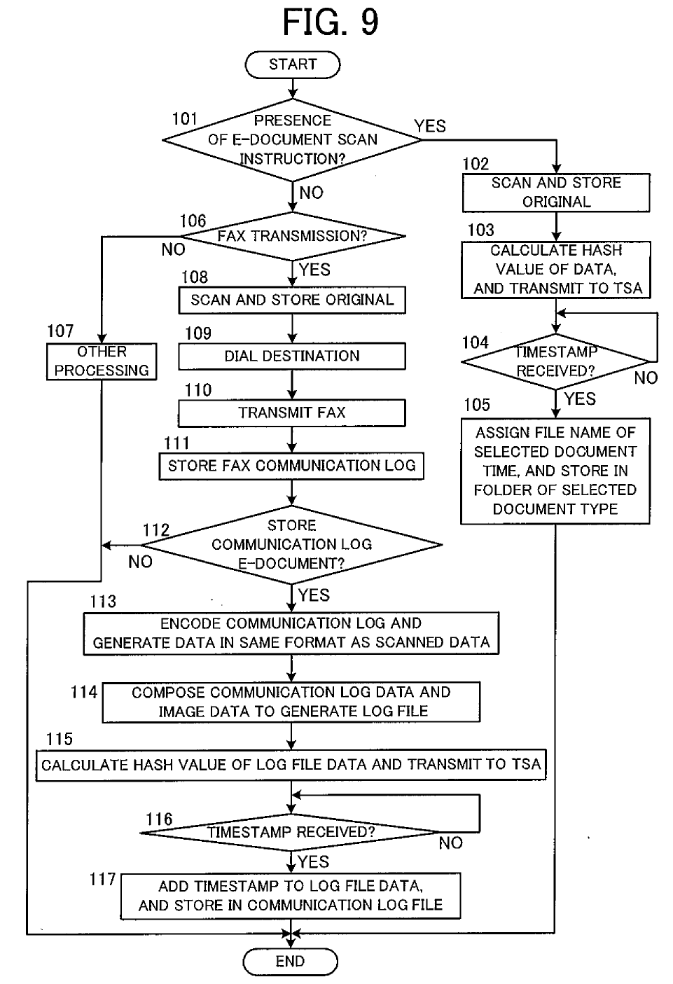

An operation of the CPU 11 carried out when the start key 33 is pressed is now described with reference to the flowchart of FIG. 9. When the start key 33 is pressed, the CPU 11 starts a program that carries out the steps illustrated in FIG. 9, and determines whether or not the e-document scan has been instructed (step 101). When e-document scan has been instructed, such as by a user selection on a scanning execution screen as illustrated in FIG. 7, the CPU 11 scans image data of an original set on the scanning unit 15. Then, the scanned image data is compressed by the CODEC 18, and stored in the image memory 16 (step 102).

Next, the CPU 11 calculates a hash value of the image data stored in the image memory 16, and transmits the calculated hash value data to the TSA 8 via the LAN interface 21, the LAN 6, and the Internet network 7 (step 103). Then, the CPU 11 determines whether or not a timestamp has been received from the TSA 8 (step 104). When a timestamp is received from the TSA 8, the CPU 11 creates a file name including a character string, a date, and a consecutive number that are capable of identifying a document name. Then, the CPU 11 stores the scanned data and the timestamp in a folder of a selected document type under the created file name, and stores management data in the management file (step 105). Then, the program is ended.

For example, when the user has selected the account book e-document scan on an e-document scanning execution screen illustrated in FIG. 8, an account book file name is created by “account book”, “date”, and “consecutive number”. Then, the scanned data and the timestamp are stored in an account book folder of the e-document storage unit 22 under the created file name, and as illustrated in FIG. 5, the file name, a period of validity of the timestamp, and a period of storage of the e-document are stored in the management file. Further, a term of storage of a document can be designated for each document type, for example, ten years for account books, or five years for purchase orders. Therefore, the period of storage can be automatically decided according to a creation date of the e-document and the term of storage for the type of such e-document.

Meanwhile, when a determination is made at step 101 that the e-document scan has not been instructed, the CPU 11 determines whether or not facsimile transmission has been instructed (step 106). When the CPU 11 determines that facsimile transmission has not been instructed, other processing (copying, etc.) is carried out (step 107). When a determination is made at step 106 that facsimile transmission has been instructed, the CPU 11 scans the image data of the original by the scanning unit 15. Then, the scanned image data is compressed by the CODEC 188, and stored in the image memory 16 (step 108).

Next, the CPU 11 controls the MODEM 19 and NCU 20 to send a dial number of a designated destination to the PSTN 5 (step 109). When communication is established, the image data stored in the image memory 16 is converted into G3 data by the CODEC 18. The G3 data is modulated by the MODEM 19, and the modulated G3 data is transmitted by facsimile from the NCU 20 via the PSTN 5 to the destination (step 110). Then, when the facsimile transmission is completed, the CPU 11 stores a facsimile communication log, i.e. a facsimile transmission destination, transmission time, a number of transmitted sheets, and a communication result, etc. as a communication log in a facsimile communication log field of the RAM 13 (step 111).

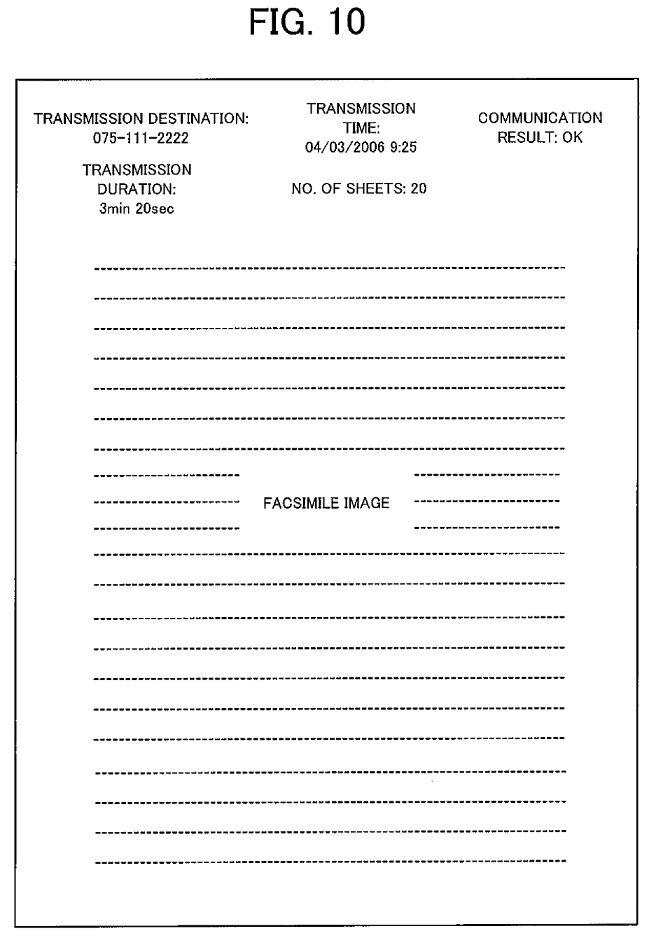

Next, the CPU 11 determines whether or not “log e-document storing transmission” has been selected, for example via the facsimile transmitting function selection screen of FIG. 6 (step 112), When the CPU 11 determines that “log e-document storing transmission” has not been selected, the CPU 11 ends the program. When the CPU 11 determines that the “log e-document storing transmission” has been selected at step 112, the CPU 11 encodes the communication log stored in the RAM 13, and generates data in the same format as the scanned data (step 113). The generated communication log data and the image data transmitted by facsimile are composed to generate log file data illustrated in FIG. 10 (step 114).

After generating the log file data, the CPU 11 calculates a hash value of the generated log file data, and transmits the calculated hash value data to the TSA 8 via the LAN interface 21, the LAN 6, and the Internet network 7 (step 115). Then, the CPU 11 determines whether or not a timestamp has been received from the TSA 8 (step 116). When receiving the timestamp from the TSA 8, the CPU 11 creates a file name by “log”, “date”, and “consecutive number”. Then, the CPU 11 stores the log file data and the timestamp in the communication log folder of the e-document storage unit 22 under the created file name, and stores the file name, a period of validity, and a period of storage in the management file.

Thus, since the communication log can be assigned with the timestamp and stored in the e-document storage unit 22, the transmission time of the facsimile transmission can be certified, and a fact that the communication log has not been altered can be also certified. In addition, at this time, the image data transmitted by facsimile is also stored, and accordingly, along with the communication log, a fact that the transmitted image data has not been altered can be confirmed.

(Second Embodiment) In the above-described embodiment, by assigning the timestamp to the communication log and storing the communication log assigned with the timestamp, the transmission time can be certified. Furthermore, by assigning time and/or the timestamp acquired from the TSA 8 to the transmission report, the transmission time can also be certified. Another embodiment in which a transmission report that displays credible time is printed by assigning the time acquired from the TSA 8 to the transmission report is now described. Except that a folder for transmission reports is provided in the e-document storage unit 22, the device configuration is similar to that of FIGS. 1-3, and a detailed description is therefore omitted.

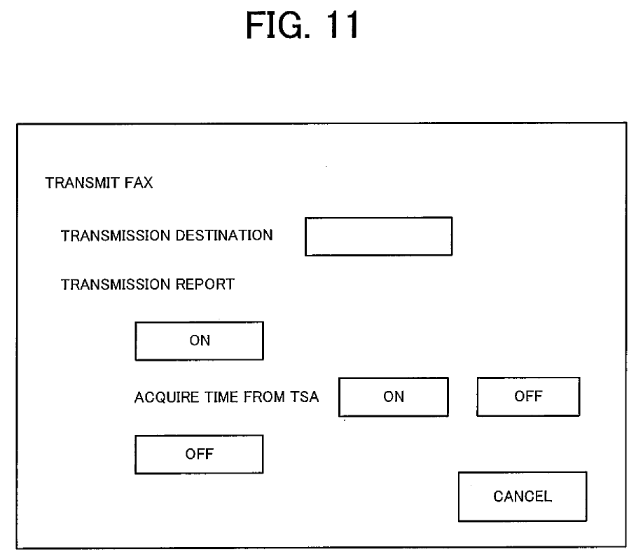

When carrying out facsimile transmission, a user sets an original to be transmitted on the scanning unit 15, and presses the FAX switching key 40 on the display and operation unit 14. A facsimile transmitting function selection screen such as that illustrated in FIG. 11 is then displayed on the LCD display unit 31. On the facsimile transmitting function selection screen, a transmission report ON and OFF selection field is displayed along with a transmission destination input field. By pressing a transmission report “ON” button, a transmission report is printed out. By pressing an “ON” button for acquiring time from the TSA 8, a transmission report assigned with time acquired from the TSA 8 is printed out.

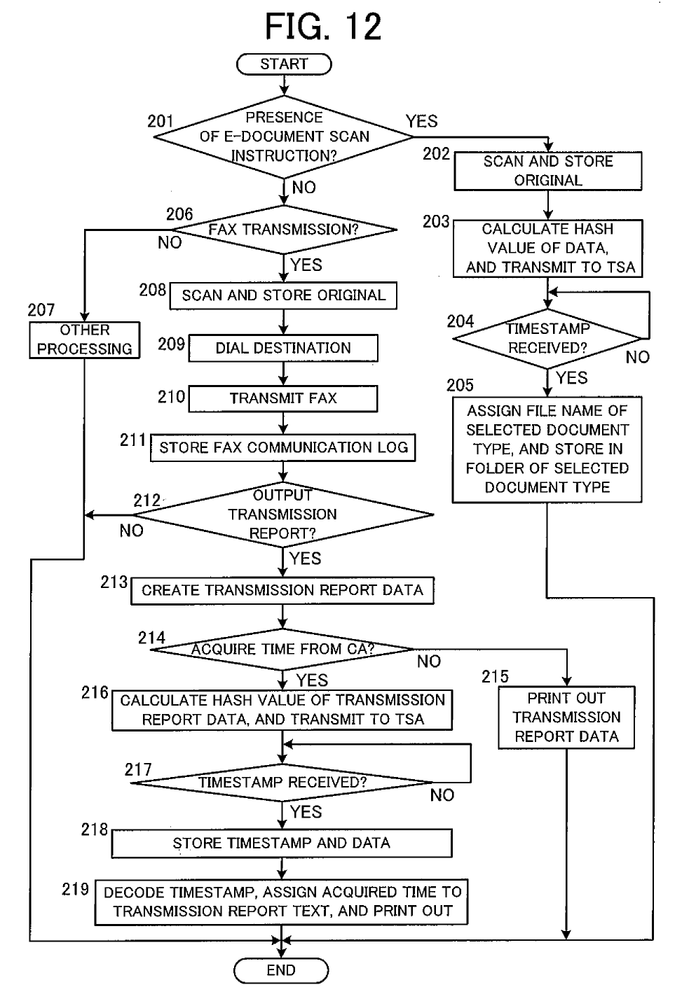

Next, with reference to the flowchart of FIG. 12, an operation of the CPU 11 carried out when the start key 33 is pressed according to the present embodiment is described. Since the operations at steps 201-211 in FIG. 12 are similar to the operations at steps 101-111 in FIG. 9, descriptions thereof are omitted. Step 212 and subsequent steps are described.

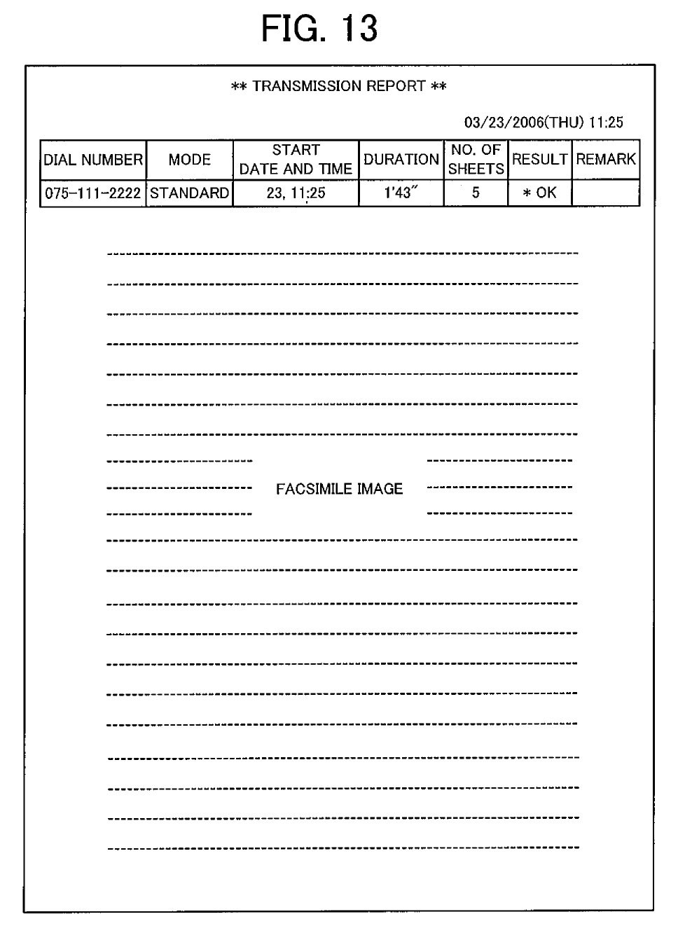

When storing the communication log in the facsimile communication log field of the RAM 13, the CPU 11 determines whether or not output of a transmission report has been selected, such as via the facsimile transmitting function selection screen of FIG. 11 (step 212). When the CPU 11 determines that output of the transmission report has not been selected, the program is ended. When the CPU 11 determines that output of the transmission report has been selected, the CPU 11 generates transmission report text data from the communication log stored in the RAM 13, and composes the transmission report text data and the image data transmitted by facsimile to generate transmission report data, such as that illustrated in FIG. 13 (step 213). Then, the CPU 11 determines whether or not a selection has been made for acquiring time from the TSA 8, such as via the facsimile transmitting function selection screen of FIG. 11 (step 214). When the CPU 11 determines that a selection has not been made to acquire time from the TSA 8, the CPU 11 prints out the transmission report data illustrated in FIG. 13 (step 215), and ends the program.

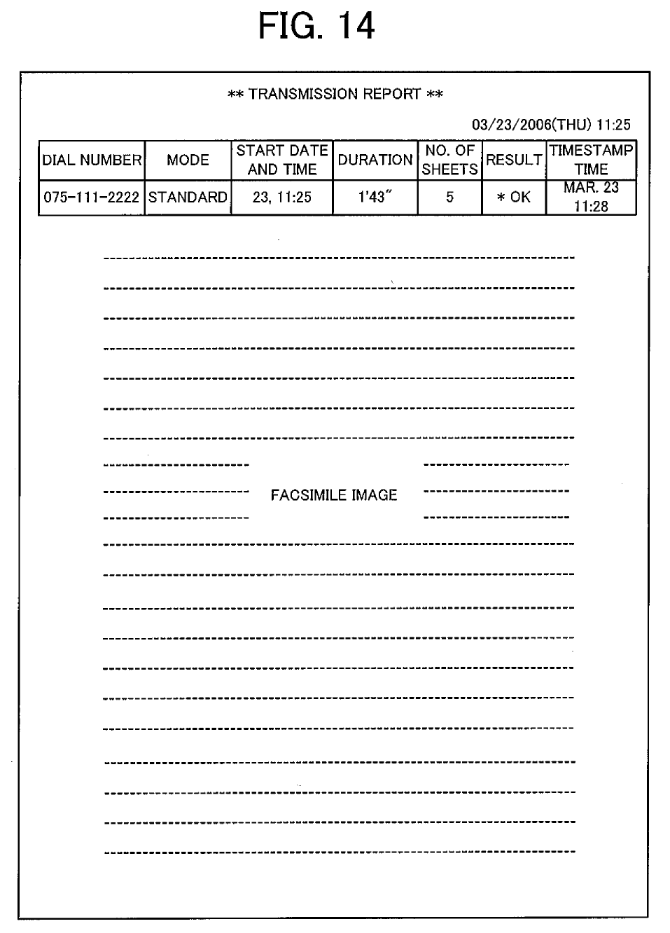

Meanwhile, when the CPU 11 determines that a selection has been made at step 214 to acquire time from the TSA 8, the CPU 11 calculates a hash value of the transmission report data, and transmits the calculated hash value data to the TSA 8 via the LAN interface 21, the LAN 6, and the Internet network 7 (step 216). Then, the CPU 11 determines whether or not a timestamp has been received from the TSA 8 (step 217). When receiving the timestamp from the TSA 8, the CPU 11 creates a file name by “transmission report”, “date”, and “consecutive number”. Then, the CPU 11 stores the transmission report data and the timestamp in the transmission report folder of the e-document storage unit 22 under the created file name, and stores the file name, a period of validity, and a period of storage in the management file (step 218). Next, the CPU 11 decodes the acquired timestamp to extract the time acquired from the TSA 8, assigns the extracted time to the transmission report text data, composes the transmission report text data and the image data transmitted by facsimile, and prints out both the transmission report text data and the image data transmitted by facsimile as illustrated in FIG. 14 (step 219).

As described above, a transmission report including time acquired from the TSA 8 is printed out. Therefore, the credibility of the time recorded on the transmission report is increased, and since the transmission report data and the timestamp are stored in the e-document storage unit 22, a fact that the transmission report and the transmission time have not been altered can be confirmed at a later date. In addition, as described above, since the image data transmitted by facsimile is also stored, a fact that the transmitted image data has not been altered is confirmed.

In the above-described embodiment, the transmission report assigned with the time acquired from the TSA 8 is printed out. However, a transmission report assigned with a timestamp acquired from the TSA 8 may also be printed out. In such a case, without storing the timestamp and the transmission report data in the e-document storage unit 22, the timestamp and the transmission report data may be printed out. Further, in the above-described embodiment, a digital MFP has been described as an example of a communication terminal device with the timestamp function of the present invention. However, the timestamp function of the present invention can also be applied to other devices such as conventional facsimile devices, etc.

While the present invention has been described with respect to embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. A communication terminal device with a timestamp function, the communication terminal device comprising:
means for communicating to transmit a document;
means for storing a time certified document; and
means for controlling to assign a timestamp to a document and to store the document assigned with the timestamp in the means for storing, when transmitting a document, the means for controlling assigns a timestamp to a data file including the transmitted document and a communication log added to the transmitted document, and stores the data file assigned with the timestamp in the means for storing.

2. A communication terminal device as claimed in claim 1, wherein the means for controlling receives the timestamp from a time stamping authority (TSA).

3. A communication terminal device as claimed in claim 2, wherein the means for controlling transmits a hash value of data composed of the communication log and the transmitted document to the TSA.

4. A communication terminal device with a timestamp function, the communication terminal device comprising:
means for communicating to transmit a document;
means for storing a time certified document; and
means for controlling to assign a timestamp to a document and to store the document assigned with the timestamp in the means for storing, when transmitting a document, the means for controlling assigns a timestamp to transmission report data of the document and stores the transmission report data assigned with the timestamp in the means for storing.

5. A communication terminal device as claimed in claim 4, wherein the means for controlling receives the timestamp from a time stamping authority (TSA).

6. A communication terminal device as claimed in claim 5, wherein the means for controlling transmits a hash value of data composed of the transmission report data and the transmitted document to the TSA

7. A communication terminal device with a timestamp function, the communication terminal device comprising:
means for communicating to transmit a document; and
means for controlling to acquire a timestamp from a time stamping authority, when transmitting a document, the means for controlling acquires time information from the time stamping authority and adds the acquired time information to transmission report data of the document.

8. A communication terminal device with a timestamp function, the communication terminal device comprising:
means for communicating to transmit a document; and
means for controlling to acquire a timestamp from a time stamping authority, when transmitting a document, the means for controlling acquires a timestamp from the time stamping authority and assigns the acquired timestamp to transmission report data of the document.

9. A digital multi function peripheral comprising the communication terminal device of claim 8.

10. A control method of a communication terminal device with a timestamp function, the control method comprising the steps of:
transmitting a document;
storing a time certified document;
assigning a timestamp to a document and storing the document assigned with the timestamp; and
when transmitting a document, assigning a timestamp to a data file including the transmitted document and a communication log added to the transmitted document, and storing the data file assigned with the timestamp.

11. A control method as claimed in claim 10, and further comprising acquiring the time stamp from a time stamping authority (TSA).

12. A control method as claimed in claim 11, and further comprising transmitting a hash value of data composed of the communication log and the transmitted document to the TSA.

13. A control method of a communication terminal device with a timestamp function, the control method comprising the steps of:
transmitting a document;
storing a time certified document;
assigning a timestamp to a document and storing the document assigned with the timestamp; and
when transmitting a document, assigning a timestamp to transmission report data of the document and storing the transmission report data assigned with the timestamp.

14. A control method of a communication terminal device with a timestamp function, the control method comprising the steps of:
transmitting a document;
acquiring a timestamp from a time stamping authority;
when transmitting a document, acquiring time information from the time stamping authority; and
adding the acquired time information to transmission report data of the document.

15. A control method of a communication terminal device with a timestamp function, the control method comprising the steps of:
transmitting a document;
acquiring a timestamp from a time stamping authority when transmitting a document, acquiring a timestamp from the time stamping authority; and
assigning the acquired timestamp to transmission report data of the document.

16. A communication terminal device with a timestamp function, the communication terminal device comprising:
a communication unit arranged to transmit a document;
a time certified document memory arranged to store a time certified document; and
a control unit arranged to assign a timestamp to a document and to store the document assigned with the timestamp in the time certified document memory, when transmitting a document, the control unit assigns a timestamp to a data file including the transmitted document and a communication log added to the transmitted document, and stores the data file assigned with the timestamp in the time certified document memory.

17. A communication terminal device with a timestamp function, the communication terminal device comprising:
a communication unit arranged to transmit a document;
a time certified document memory arranged to store a time certified document; and
a control unit arranged to assign a timestamp to a document and to store the document assigned with the timestamp in the time certified document memory, when transmitting a document, the control unit assigns a timestamp to transmission report data of the document and stores the transmission report data assigned with the timestamp in the time certified document memory.

18. A communication terminal device with a timestamp function, the communication terminal device comprising:
a communication unit arranged to transmit a document; and
a control unit arranged to acquire a timestamp from a time stamping authority, when transmitting a document, the control unit acquires time information from the time stamping authority and adds the acquired time information to transmission report data of the document.

19. A communication terminal device with a timestamp function, the communication terminal device comprising:
a communication unit arranged to transmit a document; and
a control unit arranged to acquire a timestamp from a time stamping authority, when transmitting a document, the control unit acquires a timestamp from the time stamping authority and assigns the acquired timestamp to transmission report data of the document.

20. A digital multi function peripheral comprising the communication terminal device of claim 19.
